(19) United States
(12) Patent Application Publication
(10) Pub. No.: US 2026/0368425 A1
(43) Pub. Date: Nov. 19, 2026

(54) METHODS AND SYSTEMS FOR IMPORTING TEMPLATES BETWEEN ENVIRONMENTS IN A MULTI-ENVIRONMENT ARCHITECTURE

(71) Applicant: Honeywell International Inc., Charlotte, NC (US)

(72) Inventors: Jignesh Kansara, Mira-Bhayandar (IN); Preetesh Shettigar, Mumbai (IN)

(21) Appl. No.: 19/211,320

(22) Filed: May 19, 2025

(51) Int. Cl. G06F 40/186

(52) U.S. Cl. CPC G06F 40/186

(57) ABSTRACT

The present subject matter provides methods and systems for importing templates between environments in a multi-environment architecture. The proposed solution provides collecting all objects and fields from document templates intended for import and querying a computing environment from which the document template is being imported to verify the availability of these objects and fields. If any objects or fields are missing, an error response may be generated, detailing the missing components. Further, a user may create the missing components in the environment where the document templates are intended to be imported.

### TECHNICAL FIELD OF THE INVENTION

The present subject matter relates to export/import of templates between different environments multi-environment architectures, and in particular, to resolving missing objects and fields in templates while importing from one environment to another.

### BACKGROUND OF THE INVENTION

Several enterprises require export/import of document templates between different environments in a multi-environment architecture. For example, software service like Family Print application of Salesforce is used by many enterprises that allows exporting/importing document templates from one computing environment to another. However, during the import process, if certain objects or specific fields are not available in the computing environment from which the document template is being imported, the document template cannot be converted into portable document format (PDF) thereby failing the import of the required document template. Currently, the enterprises do not have a solution to troubleshoot said failure and they are compelled to contact support team of the developers or the service providers of such applications. This challenge delays the overall functioning of the application, negatively impacts the efficiency of the enterprises and is also challenging for the support to pinpoint the cause of failure given the extensive number of objects and fields in enterprise templates. Thus, there is a need to provide a solution to the above identified challenges related to the export/import of document templates between different environments in a multi-environment architecture.

Thus, there exists a technical challenge to provide a solution to address the shortcomings related to the existing techniques related to the export/import of document templates between different environments in a multi-environment architecture.

### SUMMARY OF THE INVENTION

The present subject matter provides methods and systems for importing templates between environments in a multi-environment architecture.

In an embodiment, a method for importing a template from a first environment to a second environment in a multi-environment architecture is disclosed. The method comprises receiving a request for importing the template from the first environment to the second environment. The method further comprises identifying a plurality of data elements present in the template, wherein the plurality of data elements comprises a set of data elements of the first environment. In an aspect, the plurality of data elements comprises at least a plurality of objects and a plurality of fields correlated to the plurality of objects. The method further comprises determining whether each of the plurality of data elements is present in the second environment. The method of determining whether each of the plurality of data elements is present in the second environment, comprises sending a query message to the second environment, wherein the query message comprises information associated with the identified plurality of data elements, and wherein the query message comprises instructions for ascertaining whether each of the plurality of data elements is present in the second environment or not. The method of determining whether each of the plurality of data elements is present in the second environment, further comprises receiving a query response from the second environment, wherein the query response comprises information indicating whether each of the plurality of data elements is present in the second environment or not.

In some embodiments, the method further comprises importing the template from the first environment to the second environment based on the determining. Further, the method of importing the template from the first environment to the second environment based on the determining, comprises, when the information indicates that each of the plurality of data elements is present in the second environment, importing the template from the first environment to the second environment.

In some embodiments, the method further comprises, when the information indicates that one or more data elements from the plurality of data elements is not present in the second environment, providing a notification on a display of a user device, wherein the notification comprises information associated with the one or more data elements which are not present in the second environment. The method further comprises receiving a confirmation that the one or more data elements have been created in the second environment. The method further comprises importing the template from the first environment to the second environment, in response to receiving the confirmation. The method further comprises providing a user interface on the display, wherein the user interface comprises an option for inputting the one or more data elements. The method further comprises receiving a user input defining the one or more data elements. The method further comprises sending a create request to the second environment based on the user input for creating the one or more data elements in the second environment. The method further comprises receiving a confirmation response from the second environment indicating that the one or more data elements have been created in the second environment. The method further comprises generating a portable document format (PDF) based on the template after the template is imported in the second environment.

In another embodiment, a system for importing a template from a first environment to a second environment in a multi-environment architecture is provided. The system comprises a memory and a processing unit coupled to the memory. The processing unit is configured to receive a request for importing the template from the first environment to the second environment. The processing unit is further configured to identify a plurality of data elements present in the template, wherein the plurality of data elements comprises a set of data elements of the first environment. In an aspect, the plurality of data elements comprises at least a plurality of objects and a plurality of fields correlated to the plurality of objects. The processing unit is further configured to determine whether each of the plurality of data elements is present in the second environment. To determine whether each of the plurality of data elements is present in the second environment, the processing unit is configured to send a query message to the second environment, wherein the query message comprises information associated with the identified plurality of data elements, and wherein the query message comprises instructions for ascertaining whether each of the plurality of data elements is present in the second environment or not. The processing unit is configured to receive a query response from the second environment, wherein the query response comprises information indicating whether each of the plurality of data elements is present in the second environment or not. The processing unit is further configured to import the template from the first environment to the second environment based on the determining.

In yet another embodiment, computer-readable medium having computer-executable instructions stored thereon that, when executed by a processing unit, cause the processing unit to execute a method for importing a template from a first environment to a second environment in a multi-environment architecture, is disclosed. The computer-executable instructions, when executed by the processing unit, cause the processing unit to receive a request for importing the template from the first environment to the second environment. The computer-executable instructions, when executed by the processing unit, further cause the processing unit to identify a plurality of data elements present in the template, wherein the plurality of data elements comprises a set of data elements of the first environment. In an aspect, the plurality of data elements comprises at least a plurality of objects and a plurality of fields correlated to the plurality of objects. The computer-executable instructions, when executed by the processing unit, further cause the processing unit to determine whether each of the plurality of data elements is present in the second environment. To determine whether each of the plurality of data elements is present in the second environment, the computer-executable instructions, when executed by the processing unit, further cause the processing unit to send a query message to the second environment, wherein the query message comprises information associated with the identified plurality of data elements, and wherein the query message comprises instructions for ascertaining whether each of the plurality of data elements is present in the second environment or not. The computer-executable instructions, when executed by the processing unit, further cause the processing unit to receive a query response from the second environment, wherein the query response comprises information indicating whether each of the plurality of data elements is present in the second environment or not. The computer-executable instructions, when executed by the processing unit, further cause the processing unit to import the template from the first environment to the second environment based on the determining.

The present subject matter provides methods and systems for importing templates between environments in a multi-environment architecture. The proposed solution provides collecting all objects and fields from document templates intended for import. Further, the proposed solution may send a request to the computing environment from which the document template is being imported to verify the availability of these objects and fields. If any objects or fields are missing, an error response will be generated, detailing the missing components. This improvement will enable the enterprises to identify missing objects and fields at an early stage. Consequently, they can create the necessary objects and fields in the concerned computing environment before importing the templates, thereby streamlining the process and reducing the dependency on the support team of the service provider. Thus, the present solution provides several benefits such as, ‘Early Detection’ where the enterprises will be able to detect missing objects and fields before completing the import process, ‘self-sufficiency’ where enterprises can independently resolve issues by creating the necessary components in the concerned computing environment, and ‘efficiency’ that reduces the workload on the support team of the service provider.

This summary is provided to describe select concepts in a simplified form that are further described in the detailed description. This summary is not intended to identify key or essential features of the claimed subject matter, nor is it intended to be used as an aid in determining the scope of the claimed subject matter.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to web application user interfaces, it should be readily understood that such features are not intended to be limiting. The claims that follow this disclosure are intended to define the scope of the protected subject matter.

### BRIEF DESCRIPTION OF DRAWINGS

Embodiments of the subject matter will hereinafter be described in conjunction with the following drawing figures, wherein like numerals denote like elements, and:

FIG. 1 is a schematic diagram of an illustrative environment implementing importation of a template from a first environment to a second environment in a multi-environment architecture, according to one or more embodiments of the present disclosure;

FIG. 2 is a schematic block diagram of the system for implementing import of a template from a first environment to a second environment in a multi-environment architecture, according to one or more embodiments of the present disclosure;

FIG. 3 is a sequence diagram depicting importation of a template from a first environment to a second environment in a multi-environment architecture, according to one or more embodiments of the present disclosure;

FIG. 4 illustrates a flowchart of a method for importing templates between environments in a multi-environment architecture, according to one or more embodiments of the present disclosure;

FIG. 5 illustrates a sequence diagram depicting determining presence of a plurality of data elements in the second environment, according to one or more embodiments of the present disclosure, according to one or more embodiments of the present disclosure;

FIG. 6 illustrates a flowchart of a method of providing a notification, according to one or more embodiments of the present disclosure;

FIG. 7 illustrates a flowchart of a method of creating missing data elements in a second environment, according to one or more embodiments of the present disclosure;

FIG. 8 illustrates a computer system, according to one or more embodiments of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF INVENTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

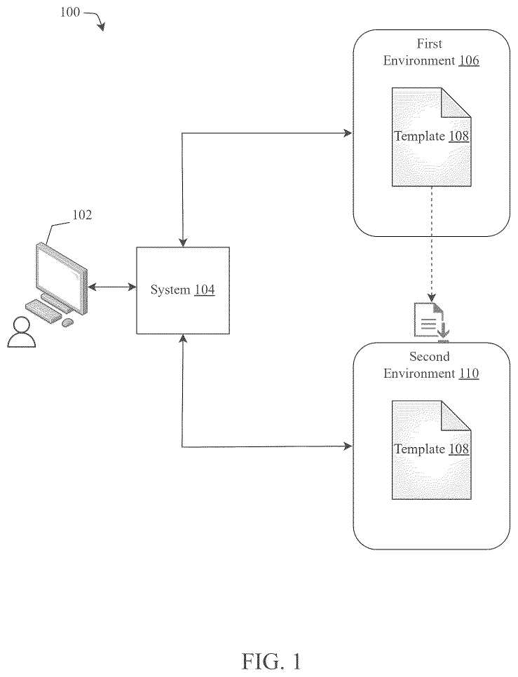

FIG. 1 is a schematic diagram of an illustrative environment 100 implementing importation of a template 108 from a first environment 106 to a second environment 110 in a multi-environment architecture, according to one or more embodiments of the present disclosure. The environment 100 depicts user device 102 connected to the first environment 106 and the second environment 110. Further, a system 104 may be connected between the user device 102 and the first environment 106 and the second environment 110. For ease of understanding, the first environment 106 may be referred to as a source environment since the template 108 may be imported from the first environment 106, similarly, the second environment 110 may be referred to as a target environment since the template 108 is supposed to be imported to the second environment 110.

In some embodiments, the environment 100 may comprises more than two environments and multiple templates may be imported from one environment to another, simultaneously. Further, the template 108 may be a document template such as, not limited to, reports, financial statements, budgets, balance sheets, customer's information documents, etc., or any other type of document that may contain one or more fields/objects and associated data. In an aspect, the one or more fields/objects and associated data of the template 108 may be referred to as data elements.

In a non-limiting example, various software as a service (SaaS) providers such as Salesforce® may provide a feature (for example, family print application) to import the template 108 from the first environment 106 to the second environment 110. However, during the import process, if certain objects or specific fields are not available in the target environment i.e., the second environment 110, the template 108 may get imported with missing data elements that may lead to failure of portable document format (PDF) generation. In this regard, the users have no other solution but to contact the support team of the SaaS provider to identify the failure's cause. However, in real time, the number of fields and objects may be extensive that poses a significant challenge for the support or Research & Development (R&D) team to pinpoint the unavailable or missing data elements in the target environment. Thus, the troubleshooting of missing data problem in the imported templates by the support or R&D team is time consuming that affects the overall efficiency of the customer which are mostly business enterprises.

The environment 110 implements the system 104 to tackle the problem as mentioned in the above paragraph. The system 104 monitors the export/import process of the templates 108 from the source environment (i.e., the first environment 106) to the target environment (i.e., the second environment 110). In this regard, the system 104 may ascertain that each of the data elements are already available before the template 108 is imported in the second environment 110.

In some embodiments, the system 104 may require an admin user to create or edit one or more date elements in such cases where the system 104 determines that the required data elements are not available in the second environment 110 or the required data elements are not in the format as required. In an aspect, the admin user may be the user device 102 or a different device controlled and accessed by an administrator of the enterprise. The monitoring of the import of the template 108 by the system 104 may provide various advantages, for example, but not limited to identification of missing data elements (objects and fields) at an early stage. Consequently, the admin user may create the necessary data elements in target environment before importing the template 108, thereby streamlining the process and reducing the dependency on the support/R&D team of the SaaS provider. In a non-limiting embodiment, the system 104 may be configured locally at the user device 102 or may be provided as a cloud service to the user device 102.

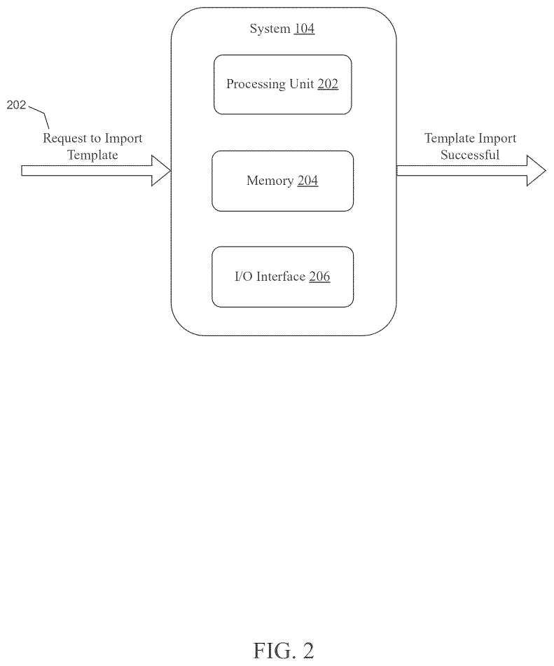

FIG. 2 is a schematic block diagram of the system 104 for implementing import of the template 108 from the first environment 106 to the second environment 110 in a multi-environment architecture, according to one or more embodiments of the present disclosure. The system 104 may comprise at least one processing unit 202, at least one memory 204, at least one input/output (I/O) interface 206, communicatively and operatively coupled with each other. Further, the system 104 may be communicatively and operatively coupled with one or more components of the user device 102, for example, a display unit (not shown in the diagram) of the user device 102.

Further, the system 104 has been depicted as receiving a request from the user device 102 to import the template 108 from the first environment 106 to the second environment 110. In response to the request to import the template 108, the system 104 is configured to ascertain that the import of the template 108 from the first environment 106 to the second environment 110 is successfully performed in such a manner that there are no missing data elements in the imported template. Further the system 104 ascertains that the imported template is successfully printed after PDF generation of the imported template.

In some non-limiting examples, the processing unit 202 may be implemented or realized as a general purpose processor or a group of general purpose processors, a content addressable memory, a digital signal processor, an application specific integrated circuit (ASIC), a field programmable gate array, any suitable programmable logic device, discrete gate or transistor logic, discrete hardware components, or any combination designed to perform the functions described here. In some examples, the processing unit 202 may be realized as microprocessors, controllers, microcontrollers, or state machines. In some examples, the processing unit 202 may be realized as a combination of computing devices, such as, a combination of digital signal processors and microprocessors, a plurality of microprocessors, one or more microprocessors in conjunction with a digital signal processor core, or any other such combination/configuration. Furthermore, alternative software implementations including, but not limited to, distributed processing, parallel processing, or virtual machine processing can also be configured to perform the methods described herein.

In some non-limiting examples, the memory 204 may be disk drives, optical storage devices, solid-state storage devices such as a random-access memory (“RAM”) and/or a read-only memory (“ROM”), which can be programmable, flash-updateable and/or the like. The at least one input/output (I/O) interface 206 provides input/output operations for the system 104. In one implementation, the I/O interface 206 may be communicatively coupled with input/output devices such as transmitter(s), receiver(s), keyboard(s), pointing device(s), display device(s), etc., to transmit and/or receive signals and/or data to/from external devices.

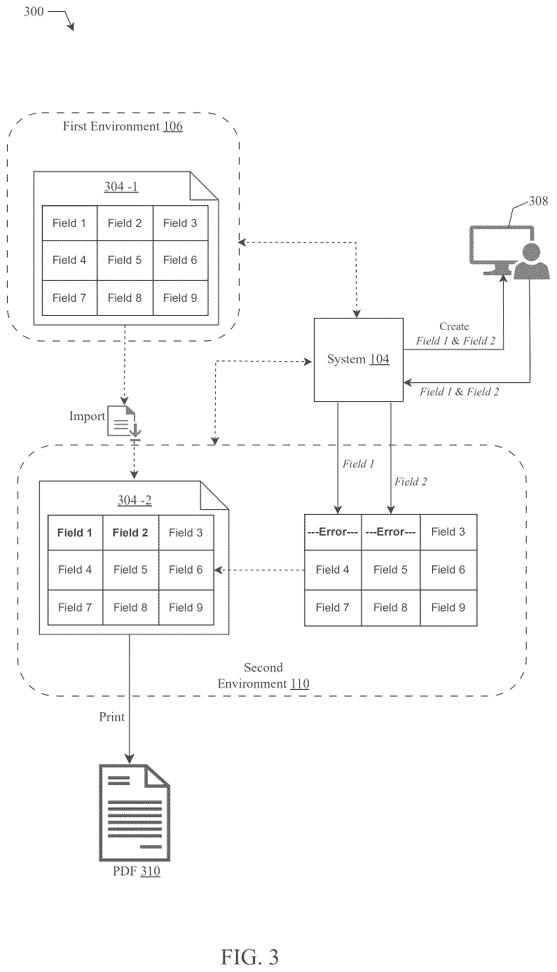

FIG. 3 is a sequence diagram 300 depicting importation of a template 304-1 from the first environment 106 to the second environment 110 in a multi-environment architecture, according to one or more embodiments of the present disclosure. The sequence diagram 300 depicts the first environment 106 having a template 304-1. The template 304-1 may be understood as similar to the template 108 as depicted in FIG. 1 and may be interchangeably used in foregoing paragraphs. The template 304-1 may comprise a plurality of data elements having at least a plurality of objects and a plurality of fields correlated to the plurality of objects. The plurality of fields may be understood as data corresponding to the plurality of objects. The template 304-1 of the first environment 106 may comprise data elements, for example, field 1, field 2, field 3, field 4, field 5, field 6, field 7, field 8 and field 9. The fields 1-9 depicted in the template 304-1 has been used merely for ease of understanding and must not be seen as limitation, whatsoever.

The template 304-1 along with the data elements i.e., fields 1-9 may be pre-configured and stored in a storage unit (not shown in figures) of the first environment 106. The template 304-1 once configured and stored in the first environment 106, may be imported to a different environment i.e., the target environment as and when required by a user. Said configuring and storing of the template 304-1 in the source environment (i.e., the first environment 106) enables the user to re-use the same template of a document where the plurality of objects remains same or slightly modified and only populating the fields or data is required for a particular process. This saves time and effort of the user and increases the productivity of the enterprise.

In an aspect, the multi-environment architecture may be understood as an architecture comprising a plurality of computing environments. Each of the plurality of computing environments may consist of exclusive and/or overlapping computing hardware and/or software resources. As mentioned in above paragraphs, various SaaS providers such as Salesforce provide features for communication between different environments. Few non-limiting examples of the features for communication between different environments may include importing/exporting documents, files and other information/data for efficient functioning of enterprises. In a non-limiting example, some enterprises using multi-environment communication features of SaaS providers may want to export a document template like the template 108 in a User Acceptance Testing (UAT) environment and later import in production environment when required for business processes. The SaaS provider often provide for export and import of templates between the UAT environment and production environment, and so on. This example is merely used for ease of understanding and must not be seen as a limitation in anyway.

Further, the sequence diagram 300 depicts the second environment 110 which is depicted as the target environment for the import of the template 304-1 i.e., the template 304-1 is to be imported in the second environment 110 from the first environment 106. Further, the sequence diagram 300 depicts that the system 104 is connected to the first environment 106, the second environment 110 and a user device 308. Examples of the user device 308 may include, a desktop computer, a smartphone, a tablet, a personal digital assistant, a laptop, and the like. The user device 308 may be operated by a user or an administrator of the enterprise.

Now, the system 104 may receive a request for importing the template 304-1 from the first environment 106 to the second environment 110. The request for importing the template 304-1 may be received from the user device 308. Upon receiving the request for importing the template 304-1, the system 104 may identify the plurality of data elements i.e., field 1, field 2, field 3, field 4, field 5, field 6, field 7, field 8 and field 9, that are present in the template 304-1 in the first environment 106. Upon identifying the plurality of data elements i.e., fields 1-9 of the template 304-1 in the first environment 106, the system 110 may determine whether each of the plurality of data elements i.e., fields 1-9 of the template 304-1 is present in the second environment 110 or not.

In some embodiments, to determine whether each of the plurality of data elements i.e., fields 1-9 of the template 304-1 is present in the second environment 110 or not, the system 104 may send a query message to the second environment 110. In an aspect, the query message may comprise an information associated with the identified plurality of data elements i.e., fields 1-9 of the template 304-1 and instructions for ascertaining whether each of the plurality of data elements of the template 304-1 is present in the second environment 110 or not.

In response to the query message sent to the second environment 110 containing the information associated with the fields 1-9 of the template 304-1 and instructions for ascertaining whether each of the fields 1-9 is present in the second environment 110 or not, the system 104 may receive a query response from the second environment 110. The system 104 may receive the query response from the second environment 110 having an information indicating whether each of the plurality of data elements is present in the second environment 110 or not. The system 104 may perform importing the template 304-1 from the first environment 106 to the second environment 110 when the information contained in the query response indicates that each of the plurality of data elements i.e., fields 1-9 is present in the second environment 110.

In some embodiments, when the system 104 determines that one or more data elements of the template 304-1 of the first environment 106 is missing in the second environment 110, the system 104 may not directly initiate the importation of the template 304-1 from the first environment 106 to the second environment 110. In other words, the system 104 may temporarily suspend the importation of the template 304-1 into the second environment 110. This is because, even if the template 304-1 gets imported to the second environment 110, the PDF generation of the template 304-1 may not capture all the required data elements and eventually show error in the places where the missing data elements of the second environment 110 were supposed to get populated during the PDF 310 generation. Also, printing of the said PDF 310 is of no use since if does not have the required details/data. Thus, to handle this situation, the system 104 may suspend the importation and may perform further processes to address this missing data (fields and/or objects) situation in the second environment 110, before importing the template 304-1 into the second environment 110 and generating the PDF 310 of the template 304-1 without any missing data elements.

In a non-limiting example, the system 104 may determine that the field 1 and the field 2 are not present in the second environment 110, thus the template 304-1 once imported from the first environment 106 into the second environment 110 may encounter missing data condition due to absence of the field 1 and the field 2 which are supposed to be populated in the PDF 310. Now, the system 104 may send a create request to the user device 308 so that the user or the admin user may be notified regarding the missing data elements i.e., the field 1 and the field 2.

Thus, when an information contained in the query response indicates that one or more data elements (field 1 and the field 2) from the plurality of data elements (fields 1-9) is not present in the second environment 110, the system 104 may provide a notification on the display (not shown in figures) of the user device 308. In an aspect, the notification may comprise information associated with the one or more data elements which are not present in the second environment 110 i.e., the field 1 and the field 2 as per the ongoing explanation. In response to receiving the create request from the system 104, the user via the user device 308 may create the field 1 and field 2. The system 104 may determine that the missing data elements i.e., the field 1 and field 2 have been created by the user when the user creates the field 1 and the field 2 and submits on the user device 308. Thereafter, the system 104 may receive a confirmation that the field 1 and field 2 have been created in the second environment 110.

In one non-limiting embodiment, for creating the missing field 1 and 2, the system 104 may provide a user interface on the display of the user device 308. The user interface provided by the system 104 may comprise an option for inputting the one or more data elements which are missing in the second environment 110 i.e., i.e., the field 1 and the field 2 as per the ongoing explanation. Further, the system 104 may receive a user input defining the one or more data elements (fields 1 and 2) once the user creates the missing fields. Now, the system 104 may send a request to create the field 1 and the field 2 to the second environment 110 based on the user input received through the user interface. Further, the system 104 may receive a confirmation response from the second environment 110 indicating that the one or more data elements (fields 1 and 2) have been created in the second environment 110.

Further, the system 104 may fetch the created fields (the field 1 and the field 2) and may temporarily store the created fields in the memory 204. Now, the system 104 may import the template 304-1 into the second environment 110 and populate the field 1 and the field 2 from the memory 204. The template 304-1 which was imported from the first environment 106 after being supplemented with the data of fields 1 and 2 may be represented as the template 304-2. The template 304-2 may contain all the objects and corresponding fields/data which are required for a successful PDF 310 generation and printing of the PDF 310. The PDF 310 based on the template 304-2 may not contain any missing data which is the expectation of the user for efficient functioning of the enterprise.

In one non-limiting example, the above explanation may be understood by means of a template used regarding a college admission form as mentioned in the below table (Table 1):

TABLE 1
COLLEGE ADMISSION FORM
Application for degree of: Master of Science

| | |
|---|---|
| [Column 1] | [Column 2] |

Personal Information

| | | | |
|---|---|---|---|
| Full Legal Name: | [Last] | [Middle] | [First] |
| Gender: | | | |

| | |
|---|---|
| Date of Birth: | [yyyy/mm/dd] |

Citizenship Status:
[US citizen/non-US
citizen]
SSN:

Contact Information

Address:
City:
State:
Zip code:
Country:
E-mail:
Phone number:

The above table (Table 1) depicts an example college admission form which may be stored in the first environment 106 as the template 304-1. Column 1 and Column 2 of the Table 1 may be understood as Objects and fields/data, respectively. The template 304-1 corresponding to the college admission form may be created/predefined capturing all the essential details/information required from a candidate who applies for the enrolment into the degree offered by the college. As depicted in Table 1, the plurality of data elements which are required for the college admission form may include ‘Personal Information’ (such as ‘Full Legal Name’, ‘Gender’, ‘Date of Birth’, ‘Citizenship Status’ and ‘SSN’), ‘Contact Information’ (such as ‘Address’, ‘City’, ‘State’, ‘Zip code’, Phone number’ and ‘E-mail’). The template 304-1 may be imported into the second environment 110 as and when required for a new candidate who applies for the admission. Now, it is convenient for the college administration to store the template 304-1 in the first environment 106 and populate the fields as per the details of a new candidate in the second environment 110, where both the first environment 106 and the second environment 110 may be managed by a single SaaS provider such as Salesforce.

In a non-limiting example, a new candidate ‘Mr. John S Williams’ wishes to apply for admission in the college for Master of Science degree. A user belonging to the college administration may import the template 304-1 and may generate a PDF of the admission form based on the details available for ‘Mr. John S Williams’. Now, for successful printing of the PDF 310 corresponding to the college admission form for ‘Mr. John S Williams’, each of the data elements need to be available in the second environment 110 so that the college admission form template (say the template 304-1) may be imported into the second environment 110 and processed further.

In a non-limiting example scenario, let's assume that each of the plurality of data elements are present in the second environment 110. In this scenario, the processes are as:

Firstly, the system 104 may first receive a request for importing the college admission form template 304-1 from the first environment 106 to the second environment 110. The request for importing the template 304-1 may be received from the user device 308 (of the college administration). Upon receiving the request for importing the college admission form template 304-1, the system 104 may identify the plurality of data elements i.e., fields to populate the ‘Personal Information’ (such as ‘Full Legal Name’, ‘Gender’, ‘Date of Birth’, ‘Citizenship Status’ and ‘SSN’), the ‘Contact Information’ (such as ‘Address’, ‘City’, ‘State’, ‘Zip code’, Phone number’ and ‘E-mail’), etc., which are present in the template 304-1 in the first environment 106. The system 104 now determines whether the plurality of data elements which are present in the template 304-1 of the first environment 106 are present in the second environment 110 or not. The presence of the plurality of data elements in the second environment 110 is crucial for the decision of the system 104 to either import the template 304-1 into the second environment 106 or not. Now, in the present example scenario, assumption has been made that each of the plurality of data elements of the template 304-1 in the first environment 106 are present in the second environment 110.

Upon determining that the plurality of data elements i.e., fields to populate the ‘Personal Information’ (such as ‘Full Legal Name’, ‘Gender’, ‘Date of Birth’, ‘Citizenship Status’ and ‘SSN’), the ‘Contact Information’ (such as ‘Address’, ‘City’, ‘State’, ‘Zip code’, Phone number’ and ‘E-mail’), etc., are present in the second environment 110.

In some embodiments, to determine whether fields to populate the ‘Personal Information’ (such as ‘Full Legal Name’, ‘Gender’, ‘Date of Birth’, ‘Citizenship Status’ and ‘SSN’), the ‘Contact Information’ (such as ‘Address’, ‘City’, ‘State’, ‘Zip code’, Phone number’ and ‘E-mail’), etc., are present in the second environment 110 or not, the system 104 may send a query message to the second environment 110. In response to the query message sent to the second environment 110, the system 104 may receive the query response indicating that the fields to populate the ‘Personal Information’ (such as ‘Full Legal Name’, ‘Gender’, ‘Date of Birth’, ‘Citizenship Status’ and ‘SSN’), the ‘Contact Information’ (such as ‘Address’, ‘City’, ‘State’, ‘Zip code’, Phone number’ and ‘E-mail’), etc., are present in the second environment 110. Further, the system 104 may perform importing the template 304-1 from the first environment 106 to the second environment 110.

The system 104 may further generate the PDF 310 based on the imported college admission form template 304-1 which may be printed. In this ideal scenario, the generated PDF 310 from the imported college admission form template 304-1 may be depicted as below in Table 2. As depicted in the Table 2, the PDF 310 may contain all the objects and corresponding fields/data which are required for a successful PDF 310 generation and printing of the PDF 310.

The PDF 310 as depicted in the Table 2 shows that an ideal scenario and there is no missing data problem in this scenario i.e., none of the fields are missing in the second environment

TABLE 2
COLLEGE ADMISSION FORM
Application for degree of: Master of Science

| | |
|---|---|
| [Column 1] | [Column 2] |

Personal Information

| | | | |
|---|---|---|---|
| Full Legal Name: | Williams | S | John |

| | |
|---|---|
| Gender: | Male |
| Date of Birth: | 1999 Nov. 5 |
| Citizenship Status: | US citizen |
| [US citizen/non-US | |
| citizen] | |
| SSN: | 999888 |

Contact Information

| | |
|---|---|
| Address: | 123, street 456 |
| City: | ABCD |
| State: | XYZ |
| Zip code: | 123456 |
| Country: | USA |
| E-mail: | abc@gmail.com |
| Phone number: | 01111111111 |

In another non-limiting example scenario, assumption has been made that few of the data elements are not present in the second environment 110. This example scenario depicts a situation where system 104 simply proceeds to import the template 304-1 which contains one or more missing data elements when imported into the second environment 110. The system 104 may receive a request for importing the college admission form template 304-1 from the first environment 106 to the second environment 110.

Upon receiving the request for importing the college admission form template 304-1, the system 104 may identify the plurality of data elements i.e., fields to populate the ‘Personal Information’ (such as ‘Full Legal Name’, ‘Gender’, ‘Date of Birth’, ‘Citizenship Status’ and ‘SSN’), the ‘Contact Information’ (such as ‘Address’, ‘City’, ‘State’, ‘Zip code’, Phone number’ and ‘E-mail’), etc., which are present in the template 304-1 in the first environment 106. Upon determining that few of the plurality of data elements i.e., fields to populate ‘Date of Birth’ and ‘SSN’ and ‘Zip code’ are not present in the second environment 110.

Thus, there are few missing data elements in the second environment 110, i.e., ‘Date of Birth’ and ‘SSN’ and ‘Zip code’ fields for ‘Mr. John S Williams’ are not present in the second environment 110. In this case, the system 104 may import the college admission form template 304-1. However, when the system 104 receives an instruction from the user device 308 to generate the PDF 310, the generated PDF 310 may contain missing data elements for ‘Date of Birth’ and ‘SSN’ and ‘Zip code’ fields. An example PDF 310 with said missing data elements has been shown below in Table 3:

TABLE 3
COLLEGE ADMISSION FORM
Application for degree of: Master of Science

| | |
|---|---|
| [Column 1] | [Column 2] |

Personal Information

| | | | |
|---|---|---|---|
| Full Legal Name: | Williams | S | John |

| | |
|---|---|
| Gender: | Male |
| Date of Birth: | --- ??? Error --- |
| Citizenship Status: | US citizen |
| [US citizen/non-US | |
| citizen] | |
| SSN: | --- ??? Error --- |

Contact Information

| | |
|---|---|
| Address: | 123, street 456 |
| City: | ABCD |
| State: | XYZ |
| Zip code: | --- ??? Error --- |
| Country: | USA |
| E-mail: | abc@gmail.com |
| Phone number: | 01111111111 |

As depicted in the above table (Table 3), despite the importation of the template 304-1 from the first environment 106 into the second environment 110, the PDF 310 shows error in the ‘Date of Birth’ and ‘SSN’ and ‘Zip code’ fields of the PDF 310 as these fields were missing in the second environment 110. Consequently, the printing of the PDF 310 fails due to the missing data problem. Now, when the present solution is implemented in the above example scenario, the missing data problem may be addressed as explained in below paragraphs:

The system 104 may receive a request for importing the college admission form template 304-1 from the first environment 106 to the second environment 110. Upon receiving the request for importing the college admission form template 304-1, the system 104 may identify the plurality of data elements i.e., fields to populate the ‘Personal Information’ (such as ‘Full Legal Name’, ‘Gender’, ‘Date of Birth’, ‘Citizenship Status’ and ‘SSN’), the ‘Contact Information’ (such as ‘Address’, ‘City’, ‘State’, ‘Zip code’, Phone number’ and ‘E-mail’), etc., which are present in the template 304-1 in the first environment 106. Upon determining that few of the plurality of data elements i.e., fields to populate ‘Date of Birth’ and ‘SSN’ and ‘Zip code’ are not present in the second environment 110. Thus, there are few missing data elements in the second environment 110, i.e., ‘Date of Birth’ and ‘SSN’ and ‘Zip code’ fields for ‘Mr. John S Williams’ are not present in the second environment 110. The system 104 may temporarily suspend the importation of the college admission form template 304-1 into the second environment 110.

Now, the system 104 may send a create request to the user device 308 so that the user or the admin user may be notified regarding the missing data elements i.e., ‘Date of Birth’ and ‘SSN’ and ‘Zip code’ fields for ‘Mr. John S Williams’ are not present in the second environment 110. In this regard, the system 104 may provide the notification on the display (not shown in figures) of the user device 308. This notification may comprise information associated with the one or more data elements (′Date of Birth′ and ‘SSN’ and ‘Zip code’ fields) which are not present in the second environment 110.

In response to receiving the create request from the system 104, the user via the user device 308 may create the ‘Date of Birth’ and ‘SSN’ and ‘Zip code’ fields in the second environment 110. The system 104 may determine that the missing data elements i.e., the ‘Date of Birth’ and ‘SSN’ and ‘Zip code’ fields have been created by the user when the user creates these missing fields and submits them on the user device 308. Thereafter, the system 104 may receive a confirmation that the ‘Date of Birth’ and ‘SSN’ and ‘Zip code’ fields have been created in the second environment 110.

For creating the missing ‘Date of Birth’ and ‘SSN’ and ‘Zip code’ fields, the system 104 may provide the user interface on the display of the user device 308. The user interface provided by the system 104 may comprise an option for inputting the one or more data elements which are missing in the second environment 110 i.e., i.e., the ‘Date of Birth’ and ‘SSN’ and ‘Zip code’ fields. Further, the system 104 may receive a user input defining the ‘Date of Birth’ and ‘SSN’ and ‘Zip code’ fields. Now, the system 104 may send a request to create the ‘Date of Birth’ and ‘SSN’ and ‘Zip code’ fields to the second environment 110 based on the user input received through the user interface. Further, the system 104 may receive a confirmation response from the second environment 110 indicating that the ‘Date of Birth’ and ‘SSN’ and ‘Zip code’ fields have been created in the second environment 110.

Further, the system 104 may import the template 304-1 into the second environment 110 and populate the ‘Date of Birth’ and ‘SSN’ and ‘Zip code’ fields along with other fields which are already present in the second environment 110. Now, the imported template with no missing data elements may be represented as the college admission form template 304-2. The college admission form template 304-2 may contain all the objects and corresponding fields/data which are required for a successful PDF 310 generation and printing of the PDF 310. The PDF 310 based on the template 304-2 may not contain any missing data which is the expectation of the user for efficient functioning of the enterprise.

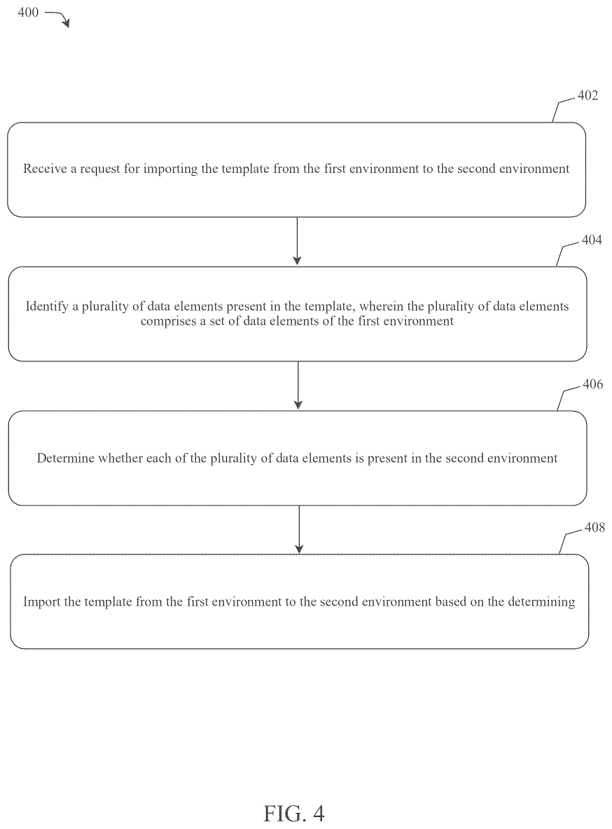

FIG. 4 illustrates a flowchart of a method 400 for importing templates between environments in a multi-environment architecture, according to one or more embodiments of the present disclosure. The steps of the method 400, described in connection with the embodiments disclosed herein, may be embodied directly in hardware, in firmware, in a software module executed by the processing unit 202 along with other components of the system 104, in any practical combination thereof.

At step 402, the method 400 may perform receiving a request 202 for importing the template 108, 304-1 from the first environment 106, 302 to the second environment 110, 306.

At step 404, the method 400 may perform identifying a plurality of data elements present in the template 108, 304-1, wherein the plurality of data elements comprises a set of data elements of the first environment 106. In an aspect, the plurality of data elements may comprise at least a plurality of objects and a plurality of fields correlated to the plurality of objects.

At step 406, the method 400 may perform determining whether each of the plurality of data elements is present in the second environment 110. The step of determining whether each of the plurality of data elements is present in the second environment 110, may comprise sending the query message to the second environment 110. In an aspect, the query message comprises information associated with the identified plurality of data elements and instructions for ascertaining whether each of the plurality of data elements is present in the second environment 110, 306 or not.

In an aspect, the step of determining whether each of the plurality of data elements is present in the second environment 110, may further comprise receiving a query response 314 from the second environment 110, wherein the query response comprises information indicating whether each of the plurality of data elements is present in the second environment 110, or not.

At step 408, the method 400 may perform importing the template 108, 304-1 from the first environment 106 to the second environment 110 based on the determining whether each of the plurality of data elements is present in the second environment 110 or not. In an aspect, the step of importing the template 108, 304-1 from the first environment 106 to the second environment 110, when the query response comprises the information indicating that each of the plurality of data elements is present in the second environment 110.

In some embodiments, the method 400 may further comprise generating a portable document format (PDF) 310 based on the template after the template 304-2 is imported in the second environment 108.

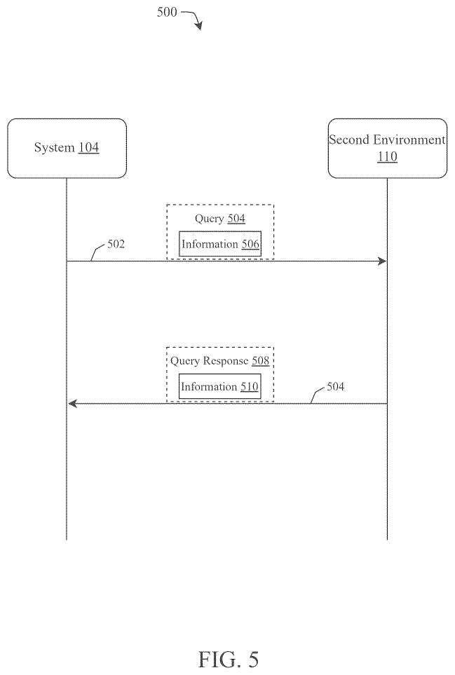

FIG. 5 illustrates a sequence diagram 500 depicting determining whether a plurality of data elements are present in the second environment 110, according to one or more embodiments of the present disclosure. The steps of the method 500, described in connection with the embodiments disclosed herein, may be embodied directly in hardware, in a software module executed by the processing unit 202 along with other components of the system 104, in any practical combination thereof.

The sequence diagram 500 depicts a communication channel 502 between the system 104 and the second environment 110. The system 104 may send a query message 504 to the second environment 110 over the communication channel 502. The query message 504 may comprise an information 506 associated with the identified plurality of data elements and instructions for ascertaining whether each of the plurality of data elements of the template 304-1 is present in the second environment 110 or not.

Further, the sequence diagram 500 depicts a communication channel 504 between the system 104 and the second environment 110. The system 104 may receive a query response 508 from the second environment 110 over the communication channel 504. The system 104 may receive the query response 508 from the second environment 110, having an information 510 indicating whether each of the plurality of data elements is present in the second environment 110, or not.

In some embodiments, the system 104 may perform importing the template 304-1 from the first environment 106 to the second environment 110 when information 510 contained in the query response 508 indicates that each of the plurality of data elements is present in the second environment 110.

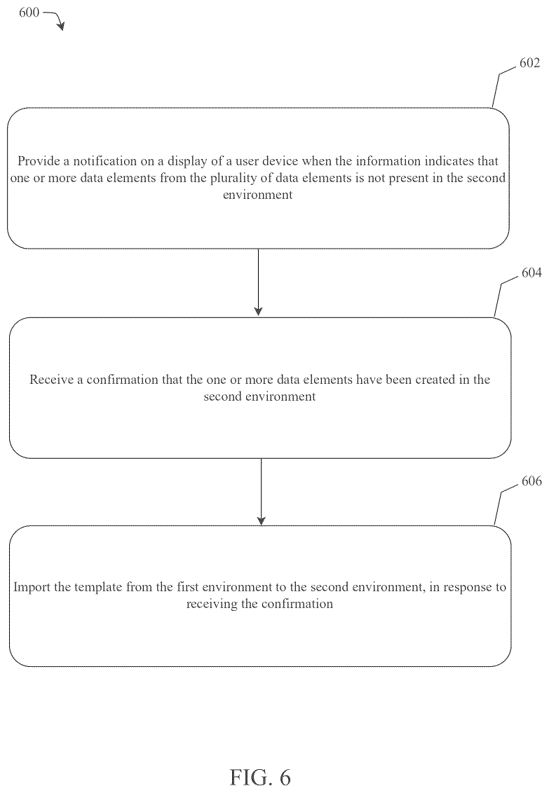

FIG. 6 illustrates a flowchart of a method 600 of providing a notification, according to one or more embodiments of the present disclosure. The steps of the method 600, described in connection with the embodiments disclosed herein, may be embodied directly in hardware, in firmware, in a software module executed by the processing unit 202 along with other components of the system 104, in any practical combination thereof.

At step 602, the method 600 may perform providing a notification on the display of the user device 308 when the information 510 indicates that one or more data elements from the plurality of data elements is not present in the second environment 110. In an aspect, the notification may comprise information associated with the one or more data elements which are not present in the second environment 110.

At step 604, the method 600 may perform receiving a confirmation that the one or more data elements have been created in the second environment 110. In an aspect, the system 104 may provide one or more options regarding creation of the one or more data elements in the second environment 110.

At step 606, the method 600 may perform importing the template 304-1 from the first environment 106 to the second environment 110, in response to receiving the confirmation that the one or more data elements have been created in the second environment 110.

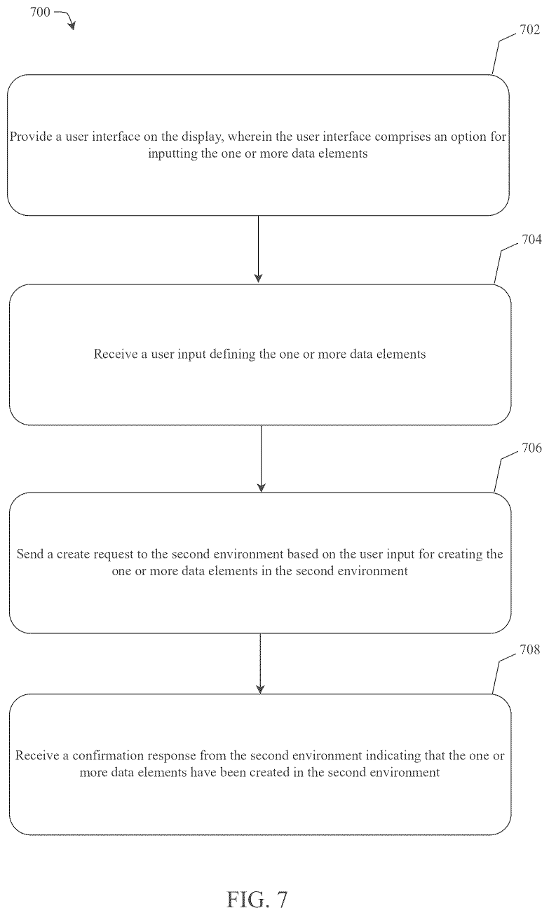

FIG. 7 illustrates a flowchart of a method 700 for creating missing data elements in the second environment 110, according to one or more embodiments of the present disclosure. The steps of the method 700, described in connection with the embodiments disclosed herein, may be embodied directly in hardware, in firmware, in a software module executed by the processing unit 202 along with other components of the system 104, in any practical combination thereof.

At step 702, the method 700 may perform providing a user interface on the display of the user device 308, wherein the user interface may comprise one or more options for inputting the one or more data elements. Upon the inputting of the one or more data elements by a user (or an admin user) of the user device 308, the system 104 may create the missing data elements in the second environment 110.

At step 704, the method 700 may perform receiving a user input defining the one or more data elements. The user (or the admin user) may input required data to define the one or more data elements that are missing in the second environment 110. The user (or the admin user) may perform inputting the required data via the user interface on the display of the user device 308.

At step 706, the method 700 may perform sending a create request to the second environment 110 based on the user input for creating the one or more data elements in the second environment 110.

At step 708, the method 700 may perform receiving a confirmation response from the second environment 110 indicating that the one or more data elements have been created in the second environment 100. Further, upon receiving the confirmation response from the second environment 110 indicating that the one or more data elements have been created in the second environment 100, the system 104 may import the template 304-1 from the first environment 106 to the second environment 110. Further, the system 104 may perform generating the PDF of the imported template 304-2 and printing the PDF for the end user.

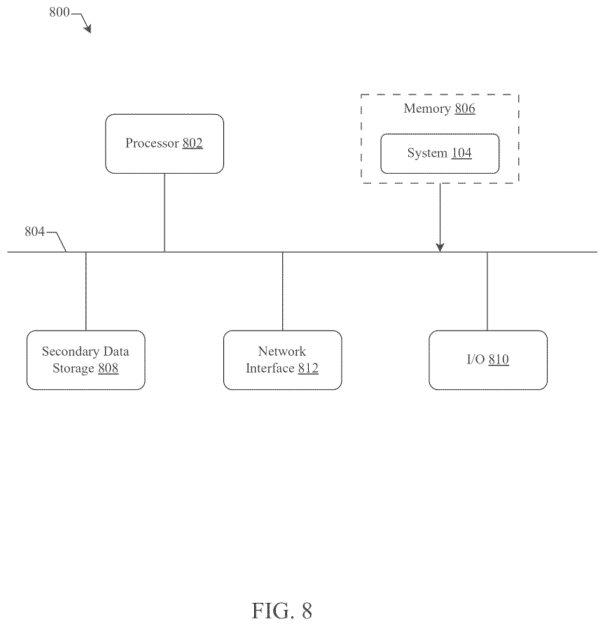

FIG. 8 shows a computer system 800 that may be used with the embodiments and examples described herein. The computer system 800 includes components that may be in a server or another computer system. The computer system 800 may execute, by one or more processors or other hardware processing circuits, the methods, functions and other processes described herein. These methods, functions and other processes may be embodied as machine readable instructions stored on computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 800 includes at least one processor 802 that may implement or execute machine readable instructions performing some or all of the methods, functions and other processes described herein. Commands and data from the processor 802 are communicated over a communication bus 804. The computer system 800 also includes a main memory 806, such as a random-access memory (RAM), where the machine readable instructions and data for the processor 802 may reside during runtime, and a secondary data storage 808, which may be non-volatile and stores machine readable instructions and data. For example, machine readable instructions for the system 104 may reside in the memory 806 during runtime. The memory 806 and secondary data storage 808 are examples of computer readable mediums.

The computer system 800 may include an I/O device 810, such as a keyboard, a mouse, a display, etc. For example, the I/O device 810 includes a display for displaying various graphical user interfaces described herein. The computer system 800 may include a network interface 812 for connecting to a network. Other known electronic components may be added or substituted in the computer system 800.

The present subject matter provides various advantages compared to the existing techniques available for importing templates between environments in a multi-environment architecture. The present subject matter solves problems arising due to missing data problem while using features like family print functions in a multi environment arrangement. The present subject matter provides for collecting all objects and fields from document templates intended for import from one environment to another. Further, the present subject matter provides for sending a request to the computing environment from which the document template is being imported to verify the availability of these objects and fields. If any objects or fields are missing, an error response will be generated, detailing the missing components. This improvement will enable the enterprises to identify missing objects and fields at an early stage.

Consequently, the present subject matter provides an option to create the missing objects and fields in the concerned computing environment before importing the templates, thereby streamlining the process and reducing the dependency on the support team of the service provider.

The solution provided by the present subject matter provides several benefits such as: ‘Early Detection’ where the enterprises will be able to detect missing objects and fields before completing the import process. ‘self-sufficiency’ where enterprises can independently resolve issues by creating the necessary components in the concerned computing environment, and ‘efficiency’ that reduces the workload on the support team of the service provider.

The subject matter may be described herein in terms of functional and/or logical block components, and with reference to symbolic representations of operations, processing tasks, and functions that may be performed by various computing components or devices. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above. The term “computer readable medium” may include any medium that is capable of storing, encoding, or carrying instructions for execution by the system 104 and that cause the system 104 to perform any one or more of the techniques of the present disclosure, or that is capable of storing, encoding or carrying data structures used by or associated with such instructions. Non-limiting computer readable medium examples may include solid-state memories, and optical and magnetic media. In an example, a massed computer readable medium comprises a computer readable medium with a plurality of particles having invariant (e.g., rest) mass. Accordingly, massed computer-readable media are not transitory propagating signals. Specific examples of massed machine readable media may include: non-volatile memory, such as semiconductor memory devices (e.g., Electrically Programmable Read-Only Memory (EPROM). Electrically Erasable Programmable Read-Only Memory (EEPROM)) and flash memory devices; magnetic disks, such as internal hard disks and removable disks; magneto-optical disks; and CD-ROM and DVD-ROM disks.

The connecting lines shown in the various figures contained herein are intended to represent exemplary functional relationships and/or physical couplings between the various elements. It should be noted that many alternative or additional functional relationships or physical connections may be present in an embodiment of the subject matter.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, devices, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

What is claimed is:

1. A method for importing a template from a first environment to a second environment in a multi-environment architecture, wherein the method comprises:
receiving a request for importing the template from the first environment to the second environment;
identifying a plurality of data elements present in the template, wherein the plurality of data elements comprises a set of data elements of the first environment;
determining whether each of the plurality of data elements is present in the second environment, wherein the determining comprises:
sending a query message to the second environment, wherein the query message comprises information associated with the identified plurality of data elements and instructions for ascertaining whether each of the plurality of data elements is present in the second environment or not; and
receiving a query response from the second environment, wherein the query response comprises information indicating whether each of the plurality of data elements is present in the second environment or not; and
importing the template from the first environment to the second environment based on the determining.

2. The method as claimed in claim 1, wherein the importing further comprises:
when the information indicates that each of the plurality of data elements is present in the second environment, importing the template from the first environment to the second environment.

3. The method as claimed in claim 1, wherein the method further comprises:
when the information indicates that one or more data elements from the plurality of data elements is not present in the second environment, providing a notification on a display of a user device, wherein the notification comprises information associated with the one or more data elements which are not present in the second environment.

4. The method as claimed in claim 3, wherein the method further comprises;
receiving a confirmation that the one or more data elements have been created in the second environment; and
importing the template from the first environment to the second environment, in response to receiving the confirmation.

5. The method as claimed in claim 4, wherein the method further comprises:
providing a user interface on the display, wherein the user interface comprises an option for inputting the one or more data elements;
receiving a user input defining the one or more data elements;
sending a create request to the second environment based on the user input for creating the one or more data elements in the second environment;
receiving a confirmation response from the second environment indicating that the one or more data elements have been created in the second environment.

6. The method as claimed in claim 1, wherein the method further comprises, generating a portable document format (PDF) based on the template after the template is imported in the second environment.

7. The method as claimed in claim 1, wherein the plurality of data elements comprises at least a plurality of objects and a plurality of fields correlated to the plurality of objects.

8. A system for importing a template from a first environment to a second environment in a multi-environment architecture, wherein the system comprises:
a memory;
a processing unit communicatively coupled to the memory, the processing unit is configured to:
receive a request for importing the template from the first environment to the second environment;
identify a plurality of data elements present in the template, wherein the plurality of data elements comprises a set of data elements of the first environment;
determine whether each of the plurality of data elements is present in the second environment, wherein the processing unit is further configured to:
send a query message to the second environment, wherein the query message comprises information associated with the identified plurality of data elements, and wherein the query message comprises instructions for ascertaining whether each of the plurality of data elements is present in the second environment or not; and
receive a query response from the second environment, wherein the query response comprises information indicating whether each of the plurality of data elements is present in the second environment or not; and
import the template from the first environment to the second environment based on the determining.

9. The system as claimed in claim 8, wherein to import the template, the processing unit is further configured to:
when the information indicates that each of the plurality of data elements is present in the second environment, import the template from the first environment to the second environment.

10. The system as claimed in claim 8, wherein the processing unit is further configured to:
when the information indicates that one or more data elements from the plurality of data elements is not present in the second environment, provide a notification on a display of a user device, wherein the notification comprises information associated with the one or more data elements which are not present in the second environment.

11. The system as claimed in claim 10, wherein the processing unit is further configured to:
receive a confirmation that the one or more data elements have been created in the second environment; and
import the template from the first environment to the second environment, in response to receiving the confirmation.

12. The system as claimed in claim 11, wherein the processing unit is further configured to:
provide a user interface on the display, wherein the user interface comprises an option for inputting the one or more data elements;
receive a user input defining the one or more data elements;
send a create request to the second environment based on the user input for creating the one or more data elements in the second environment;
receive a confirmation response from the second environment indicating that the one or more data elements have been created in the second environment.

13. The system as claimed in claim 8, wherein the processing unit is further configured to generate a portable document format (PDF) based on the template after the template is imported in the second environment.

14. The system as claimed in claim 8, wherein the plurality of data elements comprises at least a plurality of objects and a plurality of fields correlated to the plurality of objects.

15. A computer-readable medium having computer-executable instructions stored thereon that, when executed by a processing unit, cause the processing unit to execute a method for importing a template from a first environment to a second environment in a multi-environment architecture, wherein the processing unit is configured to:
receive a request for importing the template from the first environment to the second environment;
identify a plurality of data elements present in the template, wherein the plurality of data elements comprises a set of data elements of the first environment;
determine whether each of the plurality of data elements is present in the second environment, wherein the computer-executable instructions further cause the processing unit to:
send a query message to the second environment, wherein the query message comprises information associated with the identified plurality of data elements, and wherein the query message comprises instructions for ascertaining whether each of the plurality of data elements is present in the second environment or not; and
receive a query response from the second environment, wherein the query response comprises information indicating whether each of the plurality of data elements is present in the second environment or not; and
import the template from the first environment to the second environment based on the determining.

16. The computer-readable medium as claimed in claim 15, wherein to import the template, the computer-executable instructions further cause the processing unit to:
when the information indicates that each of the plurality of data elements is present in the second environment, import the template from the first environment to the second environment.

17. The computer-readable medium as claimed in claim 15, wherein to import the template, the computer-executable instructions further cause the processing unit to:
when the information indicates that one or more data elements from the plurality of data elements is not present in the second environment, provide a notification on a display of a user device, wherein the notification comprises information associated with the one or more data elements which are not present in the second environment;
receive a confirmation that the one or more data elements have been created in the second environment; and
import the template from the first environment to the second environment, in response to receiving the confirmation.

18. The computer-readable medium as claimed in claim 17, wherein the computer-executable instructions further cause the processing unit to:
provide a user interface on the display, wherein the user interface comprises an option for inputting the one or more data elements;
receive a user input defining the one or more data elements;
send a create request to the second environment based on the user input for creating the one or more data elements in the second environment;
receive a confirmation response from the second environment indicating that the one or more data elements have been created in the second environment.

19. The computer-readable medium as claimed in claim 15, wherein the computer-executable instructions further cause the processing unit to generate a portable document format (PDF) based on the template after the template is imported in the second environment.

20. The computer-readable medium as claimed in claim 15, wherein the plurality of data elements comprises at least a plurality of objects and a plurality of fields correlated to the plurality of objects.
